(19) United States
(12) Patent Application Publication
(10) Pub. No.: US 2026/0106180 A1
(43) Pub. Date: Apr. 16, 2026

(54) REDOX-ACTIVE FERRITIN AND ENZYME-BASED ELECTRODE WITH IMPROVED ELECTRON TRANSFER ABILITY, MANUFACTURING METHOD THEREOR, AND APPLICATION THEREOF

(71) Applicant: KNU-Industry Cooperation Foundation, Chuncheon-si (KR)

(72) Inventors: Cheong Hoon KWON, Samcheok-si (KR); Eui Guk JUNG, Gangneung-si (KR); Gee Chan JIN, Gapyeong-gun (KR); Hye Min YU, Samcheok-si (KR)

(73) Assignee: KNU-Industry Cooperation Foundation, Chuncheon-si (KR)

(21) Appl. No.: 19/358,536

(22) Filed: Oct. 15, 2025

(30) Foreign Application Priority Data
Oct. 15, 2024 (KR) 10-2024-0140372

(51) Int. Cl. H01M 4/90; G01N 27/327; H01M 8/16

(52) U.S. Cl. CPC H01M 4/9075; G01N 27/3271; H01M 8/16

(57) ABSTRACT

The present invention relates to an electrode with improved electron transfer ability, including: a support; and a composite structure formed on the support and in which an enzyme layer assembly including cationized ferritin and an enzyme is repeated, a manufacturing method thereof, and an application thereof.

### STATEMENT OF GOVERNMENTAL SUPPORT

The invention was made with government support under Serial No. 2022R1A2C1009690 awarded by Ministry of Science and ICT (Republic of Korea) and Serial No. 2025-RISE-10-002 awarded by Ministry of Education (Republic of Korea).

### CROSS-REFERENCE TO RELATED APPLICATION

This application claims priority to and the benefit of Korean Patent Application No. 10-2024-0140372, filed on Oct. 15, 2024, the disclosure of which is incorporated herein by reference in its entirety.

### BACKGROUND

### 1. Field of the Invention

The present invention relates to a redox-active ferritin and enzyme-based electrode with improved electron transfer ability, a manufacturing method thereof, and an application thereof.

### 2. Discussion of Related Art

Biofuel cells (BFCs) have attracted considerable attention as a promising sustainable and renewable energy solution for effective off-grid power generation in a variety of portable or implantable personalized medical devices. Despite recent advances, BFCs still face critical challenges that hinder their practical implementation, with two of the most pressing being the relatively low power output and limited operational stability. These challenges are mainly due to the inefficiency of electron transfer between an enzyme and an electrode and the propensity of enzymes to detach or deactivate from the host surface during prolonged operation. Crucially, these issues are closely related to the structure of the interfaces within the electrodes where electron transfer occurs.

Glucose oxidase (GOx), a commonly used enzyme in BFC anodes, has an active site (flavin adenine dinucleotide, FAD) located approximately 7 to 15 Å beneath an insulating protein shell. This structural feature presents a significant energy barrier to efficient electron transfer, which becomes more pronounced as the loading amount is increased for higher power output. To address this challenge, efforts are increasingly being made to facilitate electron transfer to deeply buried FAD centers by introducing redox mediators. Preferably, the mediator bridges all components within the electrode (for example, enzyme/host electrode and enzyme/enzyme), thereby minimizing the kinetic barrier (or physical gap) for electron transfer at the interfaces. That is, well-constructed electron hopping networks formed by uniformly incorporated mediators can improve the catalytic efficiency of the enzymes, leading to higher power output and cost-effectiveness of BFCs. However, most mediator electron transfer (MET) systems have incorporated redox mediators by conventional simple blending or mechanical mixing with enzymes and polymeric linkers to form an active complex on a host electrode. This approach often fails to ensure sufficient interaction between adjacent components, leading to challenges in maintaining structural stability and optimal interfacial spacing. In particular, the agglomerative nature of polymeric materials within the mediator further exacerbates these issues, potentially hindering electron transfer efficiency. In addition, widely used osmium- and ruthenium-based polymers pose significant toxicity risks, which could raise serious safety concerns, particularly in medical applications, if these materials were to leak into biological systems during repetitive operation. Therefore, an appropriate interfacial design incorporating biocompatible redox mediators provided with stable interactions and robust structural integrity is critical for optimizing the electron transfer properties within an enzyme-based anode.

### SUMMARY OF THE INVENTION

The present invention is directed to an electrode with improved electron transfer ability, including: a support; and a composite structure formed on the support and in which an enzyme layer assembly including cationized ferritin and an enzyme is repeated.

However, the technical problem to be achieved by the present invention is not limited to the aforementioned problems, and other problems that are not mentioned may be clearly understood by a person skilled in the art from the following description.

According to an aspect of the present invention, there is provided an electrode with improved electron transfer ability, including: a support; and a composite structure formed on the support and in which an enzyme layer assembly including cationized ferritin and an enzyme is repeated.

The support may be a support whose surface is functionalized with a carboxyl group.

The support may be a flat conductive support whose surface is functionalized with a carboxyl group.

The cationized ferritin may be ferritin functionalized with a cationic amine group.

The enzyme may be glucose oxidase.

The support and the cationized ferritin, and the cationized ferritin and the enzyme may each be bonded by electrostatic attraction.

The enzyme layer assembly may be repeated 5 times to 50 times and have a total thickness of 40 nm to 100 nm.

According to another aspect of the present invention, there is provided a method for manufacturing an electrode with improved electron transfer ability, the method including: (a) preparing a support; and (b) forming a composite structure in which an enzyme layer assembly including cationized ferritin and an enzyme is repeated on the support.

According to still another aspect of the present invention, there is provided a bioelectrochemical device including the electrode.

The bioelectrochemical device may be a biofuel cell or a biosensor.

### BRIEF DESCRIPTION OF THE DRAWINGS

FIG. 1 shows schematic representation of the stepwise assembly and function of n-FGOx multilayers. The cationized ferritin (red) acts as an electron mediator between GOx (green) and the electrode substrate. In the presence of glucose, GOx catalyzes the conversion of glucose to gluconolactone, releasing electrons (e⁻) that are transferred to the electrode via ferritin, thereby enhancing the electron transfer efficiency. The multilayer structure, with alternating layers of GOx and cationized ferritin, provides a highly organized pathway for electron flow, promoting optimal electrochemical performance in bioanode applications.

FIGS. 2a-2d show preparation of n-FGOx multilayers. FIG. 2a UV-vis absorption spectra of n-FGOx multilayers with the bilayer number (n) from 1 to 10. The inset shows the absorption values at 277 nm, showing a nearly linear growth. FIG. 2b QCM analysis for the n-FGOx multilayers according to the bilayer number. FIG. 2c The bilayer number-dependent film thickness of the n-FGOx multilayers, obtained from tilted FE-SEM images (right). FIG. 2d Planar and cross-sectional FE-SEM images of 30-FGOx multilayers and the corresponding elemental mapping using energy-dispersive X-ray spectroscopy (EDS) for S and Fe atoms.

FIGS. 3a-3d show electrochemical properties of cationized ferritin. FIG. 3a Cyclic voltammograms of cationized ferritin on the FTO electrode recorded with varying scan rates of 1, 5, 10, 50, 100, 150, and 200 mV s⁻¹, at 300 mmol L⁻¹ glucose in PBS solution. The scan rate-dependent FIG. 3b anodic and FIG. 3c cathodic peak current densities of cationized ferritin, indicating a surface-controlled electron transfer process. FIG. 3d Change in potential values (ΔEₚ: |E_{pc}−Eₚₐ|) as a function of log(ν). In this case, ν, E_{pc}, and Eₚₐ indicate the scan rate, cathodic peak potential, and anodic peak potential, respectively. The inset shows an enlarged graph of the anodic peak potential trend with different scan rates.

FIGS. 4a-4f show CVs and EIS Nyquist plots for n-FGOx anodes. FIG. 4a, FIG. 4c and FIG. 4e Bilayer number-dependent oxidation current densities of n-FGOx anodes recorded at different glucose concentrations (0, 10, 50, 100, and 300 mmol L⁻¹). FIG. 4b, FIG. 4d and FIG. 4f The corresponding Nyquist plots of the n-FGOx anode. Insets indicate the high frequency region of each Nyquist plot.

FIGS. 5a-5b show relationship between the current response and surface morphology of n-FGOx anodes. FIG. 5a Normalized current densities of n-FGOx anodes as a function of glucose concentration, recorded at 0.6 V. FIG. 5b Planar FE-SEM images of n-FGOx anodes with varying bilayer numbers of 0 (bare substrate), 10, 20, and 30.

FIGS. 6a-6f show comparison of the electrochemical properties of 30-FGOx and slurry-cast FGOx anodes. The normalized current densities for FIG. 6a 30-FGOx and FIG. 6b slurry-cast FGOx anodes at 0.6 V in different glucose concentrations (0, 10, 50, 100, and 300 mmol L⁻¹) and the corresponding Nyquist plots for FIG. 6c 30-FGOx and FIG. 6d slurry-cast FGOx anodes. FIG. 6e Representative equivalent circuit model derived from the Nyquist plots of both 30-FGOx and slurry-cast FGOx anodes. FIG. 6f Admittance plots for each anode. The knee frequency, where the point of charge transition behavior from diffusion-limited to charge-transfer-limited processes, was recorded at 50 Hz for the 30-FGOx anode and 41 Hz for the slurry-cast anode.

FIGS. 7a-7b show electrochemical durability testing. FIG. 7a Schematic of a three-electrode setup consisting of a working electrode (FGOx anode), a reference electrode (Ag/AgCl), and a counter electrode connected to a power supply for electrochemical measurements. The inset shows the surface of the 30-FGOx anode before and after prolonged electrochemical operation. FIG. 7b Stability tests of the 30-FGOx and slurry-cast anodes in the presence of 10 mmol L⁻¹ glucose over a 50 h continuous operation. The 30-FGOx electrode retains 85% of its initial current density (7.8 μA cm⁻²), while the slurry-cast FGOx retains only 49% (4.0 μA cm⁻²), demonstrating the superior stability and durability of the 30-FGOx electrode.

### DETAILED DESCRIPTION OF EXEMPLARY EMBODIMENTS

In this invention, we introduce a high-performance enzyme (i.e., GOx)-based bioanode with a biocompatible redox-active molecular linker, constructed through a spin coating-assisted layer-by-layer (LbL) assembly based on electrostatic attraction under physiologically benign conditions. For this, ferritin molecules were employed as both a redox-mediator and a linker to tightly integrate all electrode components without the use of polymeric linkers, minimizing internal resistance even with increased enzyme loading. Ferritin is primarily known for its role in storing and releasing iron ions via iron (Fe^{III}/Fe^{II}) oxidation-reduction reactions, but its unique properties can be harnessed to facilitate electron transfer between enzymes and electrodes. In addition, the hydrophilic functional moieties on the ferritin surface, specifically amine groups, allow for strong interaction with GOx. This simple and effective fabrication process provides a smooth and compact active layer on the host electrode with homogeneous distribution of each component (i.e., cationized ferritin and negatively charged GOx), which improves electron transfer kinetics and conversion efficiency, as well as structural integrity. In particular, our approach allows for precise modulation of the loading amount of each component by simply adjusting the number of deposited layers and/or the concentration during the LbL assembly process. This feature helps to prevent mediator overloading, which could be a clinical concern in implantable applications.

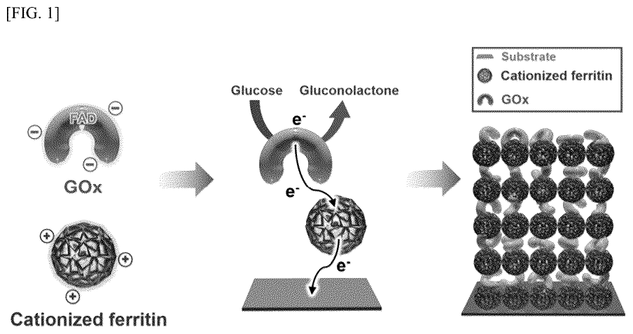

The current densities of the LbL-assembled (cationized ferritin/GOx)ₙ multilayer, denoted as n-FGOx, gradually increased with the bilayer number (n), reaching a maximum value of 36.4 μA cm⁻² (˜2.9 μA mg⁻¹ based on GOx) at n=30 (75±1.9 nm thick) in the presence of 300 mmol L⁻¹ glucose. The obtained current levels are sufficient to power low-power devices such as nano- and biomedical sensors, and self-powered devices, highlighting the practical viability of our approach for biomedical applications. Notably, the FGOx-based anodes demonstrated exceptional operational stability, retaining approximately 84.7% of their initial current density at 10 mmol L⁻¹ glucose even after 50 h of continuous operation. This sustained performance of the FGOx anode clearly demonstrates the potential for long-term use in areas that require reliable and durable power sources. This innovative LbL approach provides a foundation for the development of high-performance bioanodes for various biocompatible devices, including BFCs and biosensors, by offering both effective electron transfer and high operational stability (FIG. 1). By integrating advanced enzyme immobilization techniques with nanostructured electrode surfaces, the ferritin-based architecture significantly improves energy conversion efficiency. The robust and biocompatible nature of ferritin-based systems further supports their potential for broad application in emerging technologies, particularly in areas requiring sustainable and efficient energy generation.

Hereinafter, the present invention will be described in detail.

Electrode with Improved Electron Transfer Ability

The present invention provides an electrode with improved electron transfer ability, including: a support; and a composite structure formed on the support and in which an enzyme layer assembly including cationized ferritin and an enzyme is repeated.

First, the enzyme electrode according to the present invention includes a support, and the support may be a conductive support.

The support is for imparting conductivity, any substrate known in the art may be used, and the support may be a flat conductive support. In an embodiment of the present invention, an Au—Si wafer was used.

In particular, the surface of the support may be functionalized with a carboxyl group in order to electrostatically interact with cationized ferritin. Such a carboxyl group may be bonded to the cationized ferritin described below by electrostatic attraction. Specifically, the carboxyl group on the surface of the support can electrostatically interact with the cationized functional group (particularly a cationic amine group) of the cationized ferritin. In this case, in order to functionalize the surface of the support with a carboxyl group, the surface of the support may be treated with a polyethyleneimine solution and then with a tricarballylic acid solution while a hydroxyl group is exposed on the surface of the support. In this case, the NH group of polyethyleneimine and the COOH group of tricarballylic acid may form hydrogen bonds with each other.

Next, the enzyme electrode according to the present invention is formed on the support and includes a composite structure in which an enzyme layer assembly is repeated, and the enzyme layer assembly includes cationized ferritin and an enzyme.

The cationized ferritin is redox-active, and as the cationized ferritin is applied, a polymeric linker may be eliminated. To cationize the ferritin, the ferritin may be functionalized with a cationic amine group (—NH₃⁺). In an embodiment of the present invention, ferritin was bonded to N,N-dimethyl-1,3-propanediamine to cationize the ferritin.

Meanwhile, the enzyme is negatively charged under physiological conditions (pH 7.4 and temperature 36.5° C.) and may be one or more selected from the group consisting of glucose oxidase, catalase, and hemoglobin, and in consideration of the aspect of maintaining the stability of the enzyme, may be preferably glucose oxidase having an active site (flavin adenine dinucleotide, FAD) located approximately 7 to 15 Å beneath an insulating protein shell, but is not limited thereto.

The cationized ferritin and the enzyme may be bonded to each other by electrostatic attraction. Specifically, the cationized functional group (particularly a cationic amine group) of the cationized ferritin may electrostatically interact with the carboxyl group of the enzyme.

Based on each layer of the enzyme layer assembly, the loading amounts of the cationized ferritin and the enzyme may be 0.2 μg cm⁻² to 1.0 μg cm⁻² and 0.01 μg cm⁻² to 0.1 μg cm⁻², respectively, and preferably 0.2 μg cm⁻² to 0.5 μg cm⁻² and 0.02 μg cm⁻² to 0.08 μg cm⁻², respectively, but are not limited thereto.

The composite structure may have a mixed structure rather than a layered structure in which the enzyme layer assembly is repeated through a layer-by-layer (LbL) assembly technique, particularly a spin-assisted layer-by-layer assembly technique, and is simply separated according to electrostatic interactions between components. The number of repetitions is for optimizing the thickness and electron transfer ability, and may be 5 times to 50 times, and is preferably 20 times to 50 times, but is not limited thereto. Depending on the number of repetitions, the total thickness of the composite structure may be 40 nm to 100 nm, and preferably 60 nm to 100 nm, but is not limited thereto. In this case, when the number of repetitions and the thickness are too small, the surface coverage is insufficient due to electrostatic repulsion between the components, so that there is a limitation in which the current density decreases.

Method for Manufacturing Electrode with Improved Electron Transfer Ability

The present invention provides a method for manufacturing an electrode with improved electron transfer ability, the method including: (a) preparing a support; and (b) forming a composite structure in which an enzyme layer assembly including cationized ferritin and an enzyme is repeated on the support.

First, the method for manufacturing an electrode according to the present invention includes preparing a support [Step (a)].

The support may be a conductive support, and the material for the support has been described above, so a repeated description thereof will be omitted.

In particular, the surface of the support may be functionalized with a carboxyl group in order to electrostatically interact with cationized ferritin. Such a carboxyl group may be bonded to the cationized ferritin described below by electrostatic attraction. Specifically, the carboxyl group on the surface of the support can electrostatically interact with the cationized functional group (particularly a cationic amine group) of the cationized ferritin. In this case, the method for functionalizing the surface of the support with a carboxyl group has been described above, so a repeated description thereof will be omitted.

Next, the method for manufacturing an enzyme electrode according to the present invention includes forming a composite structure in which an enzyme layer assembly including cationized ferritin and an enzyme is repeated on the support [Step (b)].

The enzyme layer assembly includes cationized ferritin and an enzyme, and the enzyme layer assembly has been described above, so a repeated description thereof will be omitted.

In addition, the composite structure may have a mixed structure rather than a layered structure in which the enzyme layer assembly is repeated through a layer-by-layer assembly technique, particularly a spin-assisted layer-by-layer assembly technique, and is simply separated according to electrostatic interactions between components. The number of repetitions is for optimizing the thickness and electron transfer ability, and may be 5 times to 50 times, and is preferably 20 times to 50 times, but is not limited thereto. Depending on the number of repetitions, the total thickness of the composite structure may be 40 nm to 100 nm, and is preferably 60 nm to 100 nm, but is not limited thereto. In this case, when the number of repetitions and the thickness are too small, the surface coverage is insufficient due to electrostatic repulsion between the components, so that there is a limitation in which the current density decreases.

Application of Electrode with Improved Electron Transfer Ability

The present invention provides a bioelectrochemical device including the electrode.

The bioelectrochemical device according to the present invention includes the enzyme electrode, and the enzyme electrode has been described above, so a repeated description thereof will be omitted.

The bioelectrochemical device according to the present invention may be a biofuel cell or a biosensor. In the biofuel cell or biosensor, the electrode may act as an anode. Meanwhile, a second support and a Pt layer formed on the second support may be used as a cathode applicable to the biofuel cell or biosensor. In this case, the second support may be made of a conductive material, similar to the support mentioned above. Meanwhile, the surface of the second support may be functionalized with an amine group, and the Pt layer may be deposited by a known method such as sputtering.

As described above, the present invention is characterized by including, as a redox-active ferritin and enzyme-based electrode with improved electron transfer ability, a support; and a composite structure formed on the support and in which an enzyme layer assembly including cationized ferritin and an enzyme is repeated. That is, the electrode with improved electron transfer ability according to the present invention can eliminate a polymeric linker using cationized ferritin as a redox mediator and linker, and accordingly, performance is excellent as the electron transfer ability can be optimized, and durability is also excellent as the performance can be maintained even during continuous use.

Therefore, the present invention can be widely used in biofuel cells, biosensors, and the like, which require high performance and durability.

Hereinafter, preferred examples for helping with understanding of the present invention will be suggested. However, the following examples are provided only so that the present invention may be more easily understood, and the content of the present invention is not limited by the following examples.

### EXAMPLES

### Materials

Cationized ferritin, a redox-active protein complex used to enhance electron transfer, was purchased from Sigma-Aldrich (USA). Glucose oxidase (GOx) derived from Aspergillus niger with an activity of 236 U mg⁻¹ was obtained from Amano Enzyme Inc. (Japan). This enzyme catalyzes the oxidation of glucose and is essential for BFC applications due to its ability to facilitate electron transfer. Au—Si wafers used as conductive substrates for electrode fabrication were also purchased from Sigma-Aldrich. Sodium chloride (NaCl) solutions were prepared using Milli-Q deionized water (Millipore, Tokyo, Japan) to ensure high purity for all experimental procedures. Branched polyethyleneimine (PEI, Mw˜800 g mol⁻¹), which was used as a polyelectrolyte to facilitate the LbL assembly process, was purchased from Sigma-Aldrich, along with TC, which was used as a buffering agent to maintain optimal pH conditions during the LbL assembly process.

### Surface Treatment of Au—Si Wafer

The surface treatment of Au—Si wafers was essential to establish a stable foundation for the subsequent introduction of cationized ferritin as the initial layer of the assembly. The Au—Si wafers were first immersed in RCA solution for 10 min to remove surface contaminants and create a negatively charged surface by oxidizing organic residues and exposing hydroxyl groups. This treatment ensures a clean and reactive surface for subsequent coating steps. The wafers were then immersed in a 1 mg mL⁻¹ solution of polyethyleneimine (PEI) for 6 h. During this step, a PEI coating formed on the wafer surface through electrostatic and hydrogen bonding interactions between the positively charged amine (NH₂) groups of PEI and the negatively charged hydroxyl (OH⁻) groups on the Au—Si wafer. After the PEI coating step, the wafers were thoroughly rinsed with deionized water to remove any weakly adsorbed PEI molecules, ensuring a uniform and stable layer. To introduce cationized ferritin, the wafers were immersed in a 1 mg mL⁻¹ solution of tricarballylic acid (TC) for 6 h. In this step, hydrogen bonding occurred between the NH groups of the previously adsorbed PEI layer and the carboxyl groups of TC, further stabilizing the PEI layer and introducing additional functional groups for subsequent LbL assembly. Finally, the wafers were rinsed again in deionized water to remove any loosely bound TC, and then dried with an air stream. This process results in a clean, functionalized Au—Si wafer surface, ready for the assembly of redox-active proteins and enzymes in the next steps of BFC anode preparation.

Preparation of the n-FGOx Multilayer Film

The multilayered films of cationized ferritin and GOx were constructed on the pre-treated Au—Si wafer using the spin coating-assisted LbL assembly technique. First, the cationized ferritin solution was dropped on the substrate and spun to distribute the material evenly, forming a thin, uniform ferritin layer. Subsequently, the GOx layer was deposited on the ferritin-coated substrate by the same drop and spin-coating process, forming a (cationized ferritin/GOx)₁ bilayer film. This deposition sequence was repeated 0, 5, 10, 15, 20, 25, and 30 times to build up the desired number of multilayers. Each LbL deposition cycle involved the precise application of a solution containing either cationized ferritin or GOx, followed by spinning the wafer to ensure uniform spreading and adhesion of each layer through electrostatic interactions and hydrogen bonding. The NaCl concentration in the GOx solution was optimized to modulate the deposition behavior. UV-vis spectroscopy showed that increasing the NaCl concentration from 0 to 0.5 mmol L⁻¹ enhanced the absorbance at 277 nm for 10-FGOx multilayer films, indicating a higher loading of active materials within the multilayers. This suggests that NaCl can modulate the ionic strength of the adsorption solution, which affects both the deposition behavior and the conformation of the multilayer. This process results in highly ordered multilayer structures, where the alternating deposition of redox-active ferritin and enzymatic GOx layers is carefully controlled to ensure optimal electron transfer efficiency for BFC applications.

### Preparation of the Slurry-Cast FGOx Anode

To prepare the conventional slurry-cast FGOx, we uniformly mixed enzymes, redox mediators, and crosslinking agents, ensuring that the components remained in solution without precipitation. The anodic catalyst is formulated from the crosslinking adducts of glucose oxidase (GOx, 41 wt %), cationized ferritin (52 wt %), and polyethylene glycol diglycidyl ether (PEGDGE, 7 wt %). The selection of the optimal concentration of the crosslinking agent was based on a comprehensive evaluation of both the current density and the long-term stability of the BFC electrodes, as detailed in previous studies. This optimization process was conducted at a controlled temperature of 4° C. for a duration of 24 h to promote effective crosslinking and enzyme retention.

### Characterization

The surface and cross-sectional morphologies of the n-FGOx multilayers were analyzed using field-emission scanning electron microscopy (FE-SEM, Hitachi S4800, Japan) to provide detailed imaging of the multilayer structure and its uniformity. The growth behavior of the n-FGOx multilayer during the LbL deposition process was investigated using UV-vis spectroscopy (Lambda 365+, PerkinElmer) and quartz crystal microbalance (QCM, QCM 200, SRS, USA) measurements. The loading mass per layer (ΔM) was calculated from the frequency variation (ΔF) of the QCM sensor during LbL deposition using the Sauerbrey equation:

$$Δ F ( Hz ) = - \frac{2 {F}_{0}^{2}}{A \sqrt{{ρ}_{q} {μ}_{q}}} \cdot Δ M$$

where F₀ is the resonant frequency (˜5 MHZ), A is the active area of the sensor (cm²), ρ_{q} is the density of the quartz crystal (2.65 g cm⁻³), and μ_{q} is the shear modulus of the quartz (2.95×10¹¹ g cm⁻¹ s⁻²). This equation simplifies to:

$$Δ F ( Hz ) = - 56.6 \cdot Δ M$$

where AMA represents the mass per unit area (ng cm⁻²).

### Electrochemical Measurements

A three-electrode electrochemical system was employed, consisting of (cationized ferritin/GOx)ₙ Au—Si wafer as a working electrode, an Ag/AgCl reference electrode, and a platinum (Pt) counter electrode. For the working electrode, the top end of the n-FGOx assembly Au—Si wafer was firmly connected to a copper wire to ensure a stable electrical contact. Cyclic voltammetry (CV) measurements were conducted within the potential range of −0.6 to +0.6 V, using an electrochemical analyzer (Ivium-n-Stat, Ivium Technologies, Netherlands). Electrochemical impedance spectroscopy (EIS) tests were performed over a frequency range of 0.2 Hz to 100 kHz, using a perturbation amplitude of 0.01 V. The resulting Nyquist plots, representing the real (Z′) and imaginary (Z″) components of the impedance, were analyzed using Z View software (version 2.8d, Scribner Associates Inc., USA).

All experiments were carried out in a batch mode with 50 mL of phosphate-buffered saline (PBS) solution (20 mmol L⁻¹ phosphate and 140 mmol L⁻¹ NaCl, pH 7.4) at 36.5° C., under quiescent (non-stirred) conditions in an electrochemical cell. The distance between the working (anode) and counter (cathode) electrodes was maintained at approximately 1 cm, and no membrane was used to separate the electrodes. This setup allowed direct interaction between the BFC components.

### Warburg Impedance Coefficient Plots

The slope of each curve represents the Warburg impedance coefficient (σ_{w}), which can be determined from the impedance spectra in the low-frequency region by applying the following equation:

$${Z}^{′} = {R}_{s} + {R}_{ct} + {σ}_{w} {ω}^{- 0.5} ,$$

where Rₛ is the equivalent series resistance (ESR), R_{ct} is the charge transfer resistance, and ω is the angular frequency.

The Warburg coefficient (σ_{w}) reflects ion diffusion limitations in the system, and its value can be extracted from the linear region of the plot in the low-frequency domain.

### Example 1: Fabrication of the Multilayered n-FGOx Composite Film

Considering the physiological conditions of mammals suitable for biomedical applications, all processes, including electrode fabrication and electrochemical tests, were performed at pH 7.4 and a temperature of 36.5° C. Under these conditions, GOx, with an isoelectric point ranging between 4.3 and 4.8, has a negative charge. A key aspect of this study is the utilization of ferritin molecules not only as redox-active mediators to facilitate efficient electron transfer but also as linkers that maintain structural integrity without the need for conventional insulating polymeric binders. To achieve this, the ferritin was functionalized by coupling with N,N-dimethyl-1,3-propanediamine (DMPA), which imparts a positive charge at physiological pH. The cationized ferritin is then LbL-assembled with negatively charged GOx molecules using an electrostatic attraction-based spin self-assembly process. This LbL process allowed precise control over the formation of the multilayer composite thin films, ensuring homogeneous integration of each component.

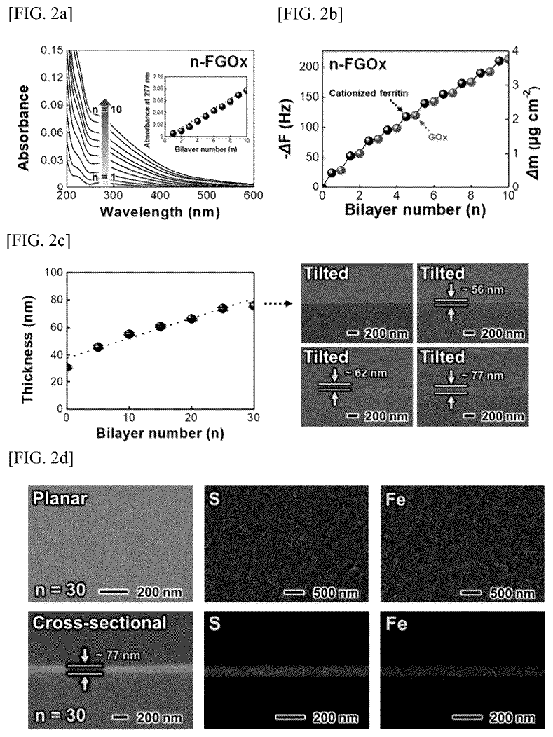

The deposition behavior of the ferritin/GOx multilayers (i.e., n-FGOx) was qualitatively and quantitatively analyzed using UV-vis spectroscopy and quartz crystal microbalance (QCM) measurements. Since the characteristic UV-vis spectra of ferritin and GOx almost overlap due to the hydrous ferric oxides of ferritin and the flavin groups of GOx, the film growth was monitored by observing the changes in absorption intensities at 277 nm (FIG. 2a). The peak intensity increased regularly as the bilayer number of the n-FGOx multilayer increased from 1 to 10, indicating precise control over the incorporation of each component within the composite film. The precise deposition of each layer during the LbL process was further validated by QCM measurements, which showed a loading amount of 0.37±0.04 μg cm⁻² for ferritin and 0.05±0.01 μg cm⁻² for GOx (FIG. 2b).

The thickness of the n-FGOx multilayer films increased linearly with the bilayer number, reaching approximately 77 nm for 30 bilayers (i.e., 30-FGOx), based on the field-emission scanning electron microscopy (FE-SEM) measurements (FIG. 2c). In this case, the average thickness of each bilayer can be estimated to be approximately 2.5 nm, which is significantly less than the typical diameter of a ferritin molecule, around 12 nm. This indicates that the n-FGOx composite films have a mixed structure rather than a straightforward layered architecture, which is more favorable for the formation of omnidirectional three-dimensional (3D) electron hopping networks. In addition, energy-dispersive X-ray spectroscopy (EDS) mapping of the 30-FGOx films reveals a uniform distribution of all components without any visible agglomeration or segregation (FIG. 2d). In particular, the spin coating-assisted LbL assembly creates a smooth surface morphology and a compact film density (0.67 g cm⁻³) due to the centripetal and air shear forces, which promotes efficient electron transfer kinetics and high reactivity. These structural properties make the FGOx films suitable for a variety of wearable and implantable nano- and micro-medical devices.

### Example 2: Electrochemical Properties of n-FGOx Composite Films

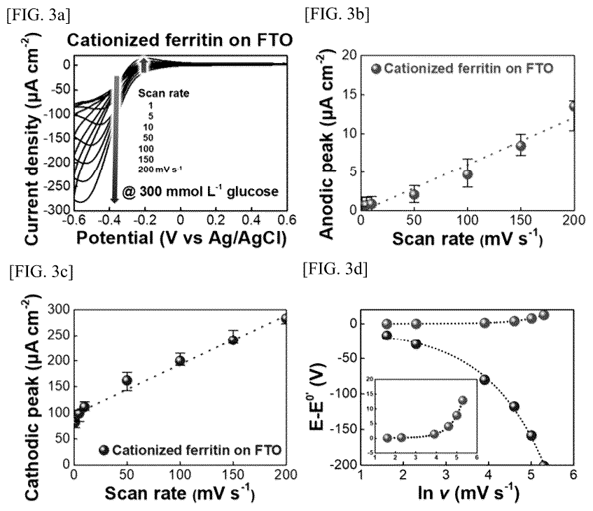

Cyclic voltammetry (CV) was employed to assess the electrochemical behavior of cationized ferritin immobilized on a fluorine-doped tin oxide (FTO) electrode in the presence of 300 mmol L⁻¹ glucose, at scan rates ranging from 1 to 200 mV s⁻¹ (FIG. 3a). The voltammograms show well-defined oxidation and reduction peaks, originating from the redox reaction of the iron complex (ferrihydrite) within the ferritin core, indicating a highly reversible electrochemical activity towards glucose. This result suggests that ferritin can effectively mediate electron transfer within the BFC systems. As the scan rate increases, the current densities associated with both the anodic (centered around −0.17 V) and cathodic (between −0.41 V and −0.56 V) peaks grow proportionally, indicating that the electrochemical reaction is a surface-redox controlled process (FIGS. 3b and c). The widening of the oxidation-reduction gap (ΔEp) at higher scan rates can be attributed to increased kinetic overpotentials and faster electron transfer rates (FIG. 3d).

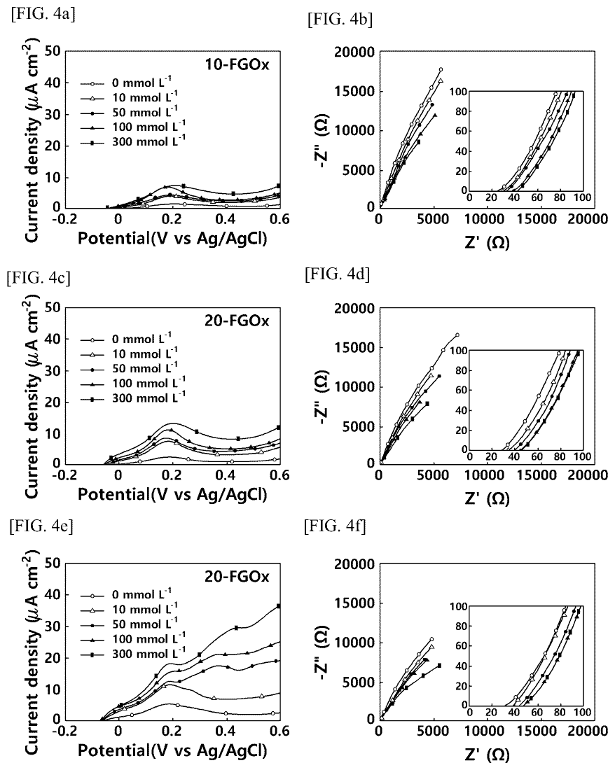

Based on these results, the electrochemical properties of the n-FGOx composite films were investigated by CV and electrochemical impedance spectroscopy (EIS). FIG. 4 shows the bilayer number-dependent CV profiles of the n-FGOx and the corresponding Nyquist plots at different glucose concentrations ranging from 0 to 300 mmol L⁻¹ in phosphate-buffered saline (PBS) solution. With increasing bilayer number and glucose concentration, the response current densities increased regularly, reaching the highest value of 40 μA cm⁻² at 300 mmol L⁻¹ for the 30-FGOx electrodes (FIGS. 4a, c, e). This enhanced catalytic activity of the n-FGOx can be attributed to the higher enzyme loading with increasing bilayer number (n), which also results in a larger active surface area for efficient glucose interaction and electron transfer. Although the internal resistance of the n-FGOx electrodes tends to increase with increasing bilayer number due to the insulating nature of enzymes (i.e., GOx) (FIGS. 4b, d and f), it is worth noting that the thin-film structure with a homogeneous distribution of the electrode components is highly advantageous in overcoming charge transfer kinetics during electrochemical sweeps. For example, in the case of the 30-FGOx anodes, the smallest semicircles were observed at 300 mmol L⁻¹ glucose, suggesting that the electrode exhibits the most efficient electron transfer under these conditions, even at the highest output current density. The enhanced glucose oxidation at higher concentrations is likely due to the multilayer structure, which provides more active sites and facilitates rapid electron transfer between the enzyme and the electrode. In particular, uniformly incorporated cationized ferritin, bridging the interfaces of GOx/GOx and/or GOx/host electrode interfaces, creates continuous and robust pathways for efficient electron flow within the electrodes, significantly minimizing the potential losses typically observed in traditional bioanode designs.

Furthermore, the electrochemical activity of the ferritin, originating from the reversible redox reaction of its stable iron complex core (Fe^{III}/Fe^{II}), can contribute to the overall current output of the GOx-based anode electrodes. To verify this, the electrochemical behavior of the n-FGOx anodes was tested in the absence of glucose in PBS. Given that the ferritin molecule itself does not have active sites or functional groups that would typically interact with glucose, the current responses in this system reflect only the contribution of ferritin. The CVs reveal that the current densities of the n-FGOx anodes increase regularly with increasing bilayer numbers, indicating that the presence of ferritin enhances the electrochemical activity of the n-FGOx anodes.

### Example 3: Correlation of Multilayer Deposition Behavior with Current Output

In general, the surface morphology of the electrode has a significant impact on the output performance of electrochemical systems. Specifically, a smooth, well-covered active layer on the electrode surface enables more efficient energy conversion with low overpotential, even at high fuel concentrations.

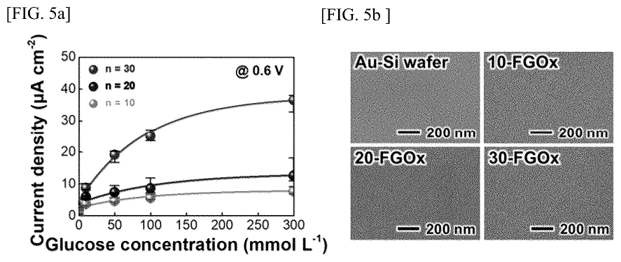

FIG. 5a shows the relationship between current densities and glucose concentrations (0-300 mmol L⁻¹) for n-FGOx anodes with different bilayer numbers at 0.6 V. The results demonstrate that increasing the number of bilayers enhances the glucose oxidation process, as indicated by the rise in current density. For the 10- and 20-FGOx anodes, the current densities increased gradually with glucose concentration but reached relatively low current plateaus at around 8 μA cm⁻² and 13 μA cm⁻², respectively, at 300 mmol L⁻¹ respectively. In contrast, the 30-FGOx anode shows a significantly improved current density, reaching approximately 37 μA cm⁻² at the same glucose concentration, indicating a better catalytic performance compared to lower bilayer assemblies. The electrochemical improvement can be attributed to the higher enzyme immobilization, which ensures better access to the glucose molecules and improved electron transfer kinetics. These phenomena can be explained by the different deposition behavior of the electrostatic interaction-induced LbL assembly of dilute charged materials in water.

As mentioned above, the average thickness per bilayer was quite thin (approximately 2.5 nm), even compared to the ferritin molecule, which has a diameter of ˜12 nm. This is due to the electrostatic repulsion between the same charged components, resulting in insufficient surface coverage. Therefore, although the LbL assembly ensures a uniform distribution of the electrode components without noticeable surface agglomeration (FIG. 5b), the quality of the surface coverage resulting from the deposition process can significantly affect performance. Specifically, insufficient surface coverage of the FGOx layer on the electrode, as seen in the case of 10 and 20 bilayers, can result in a limited number of active sites and/or mediators, hindering efficient electron transfer and leading to relatively low current densities. On the other hand, the 30-FGOx anode may have a denser and more continuous layer of ferritin and GOx, ensuring better surface coverage and a more interconnected network of redox-active centers. The well-ordered nanostructure also enhances the electron transfer capacity of the electrodes, increasing their maximum potential at higher glucose concentrations. Particularly, the phenomenon of a continuous increase in total current density for 30-FGOx anodes is in good agreement with Michaelis-Menten kinetics, where an increasing amount of enzyme enhances the rate of glucose oxidation. That is, the 30-FGOx anode with sufficient surface coverage likely facilitates a faster and more efficient catalytic turnover, allowing for a higher maximum current density at high glucose concentrations.

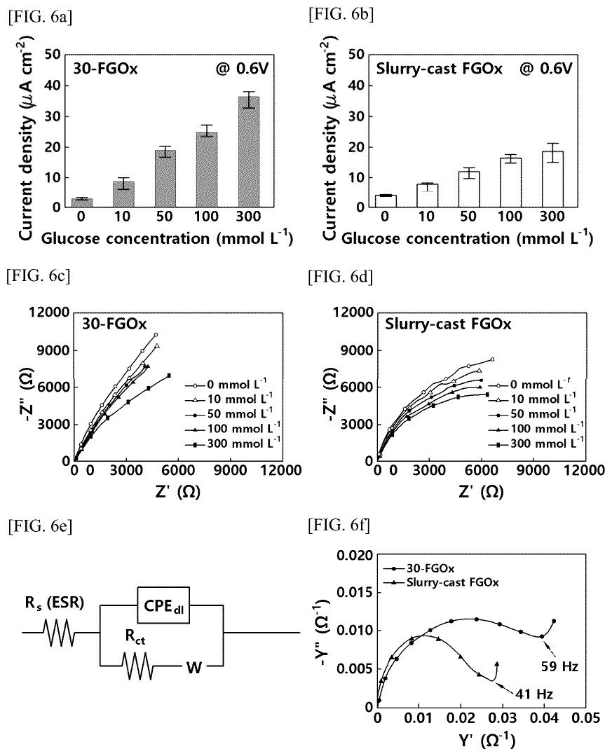

To further demonstrate the impact of surface morphology on performance, we investigated the electrochemical responses of FGOx anodes prepared by both LbL assembly and the traditional slurry casting process, at varying glucose concentrations (0, 10, 50, 100, and 300 mmol L⁻¹). The LbL-assembled 30-FGOx anodes exhibited the highest current density of nearly 40 μA cm⁻² at the highest glucose concentration of 300 mmol L⁻¹ (FIG. 6a). However, the slurry-cast FGOx anodes displayed a significantly low current density of approximately 18.7 μA cm⁻² at the same glucose concentration, despite a similar loading amount of each electrode component (FIG. 6b). These observations clearly demonstrate that insufficient interactions between the components (i.e., ferritin and GOx) within the electrode, caused by the simple mechanical mixing process, may lead to poor uniformity and undesirable material agglomeration. Therefore, this results in a low active surface area and ultimately hinders effective electron transfer at the interfaces.

Importantly, the charge diffusion characteristics at the electrode/electrolyte interfaces are also significantly influenced by the structural features of the FGOx anodes. Basically, the facile diffusion of glucose molecules in the electrolyte towards the anode is one of the crucial factors for efficient energy conversion. For glucose, the multiple hydroxyl (—OH) groups have a high affinity for cationized ferritin, specifically forming hydrogen bonding interaction with the —NH groups of DMPA. Therefore, the uniformly distributed ferritin molecules within the LbL-assembled 30-FGOx anodes can act as effective pathways for glucose diffusion from the surface to the interior of the anode, significantly reducing the interfacial resistance. However, partial agglomeration issues in the FGOx slurries can lead to higher interfacial resistance due to electrostatic repulsion between glucose and the negatively charged GOx molecules, resulting in poor ion diffusion kinetics at the electrode/electrolyte interfaces. To verify this, the Nyquist plots for each anode were obtained from the fit with the representative equivalent circuit (FIGS. 6c-e). In this case, the Warburg lines of each anode became more sloped with increasing glucose concentration, a typical behavior resulting from the formation of concentration gradients at the anode surface. However, the LbL-assembled 30-FGOx anode exhibited much better ion diffusion kinetics (Warburg impedance coefficient ˜273.5 Ω s^{-0.5}) than that (˜173.6 Ω s^{-0.5}) of the slurry-cast anode, indicating that the LbL assembly of cationized ferritin and GOx, with well-defined interactions, creates optimal structural features for the formation of efficient charge transfer networks. Additionally, the 30-FGOx anode exhibited a higher knee frequency of ˜59 Hz compared to the slurry-cast anode (˜41 Hz), further demonstrating superior mass transport characteristics during electrochemical operation (FIG. 6f).

### Example 4: Operational Stability of the n-FGOx Anode

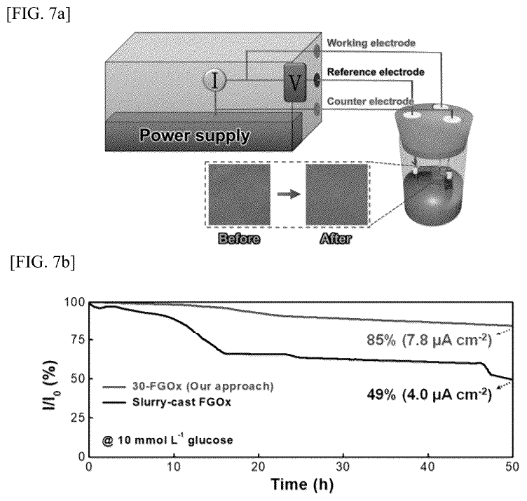

Long-term stability is a critical factor in the practical implementation of BFCs, especially for continuous applications such as implantable medical devices or environmental sensors. To evaluate the stability of the n-FGOx anode, we performed a 50 h chronoamperometric test in the presence of 10 mmol L⁻¹ glucose (FIG. 7a). As shown in FIG. 7b, the current density of the 30-FGOx anode gradually decreased over time, but maintained 85% of its initial current density after 50 h of continuous operation, corresponding to a final current density of 7.8 μA cm⁻². In this case, the 30-FGOx anodes show no noticeable surface changes, such as corrosion or delamination of the active layer, after prolonged electrochemical operation, indicating good physical stability (inset of FIG. 7a). On the other hand, the slurry-cast FGOx anode retained only 49% (4.0 μA cm⁻²) of its initial value after 50 h, indicating poor operational stability. The superior electrochemical retention stability of the LbL-assembled 30-FGOx anode compared to the slurry-cast anode clearly demonstrates its structural integrity with homogeneous distribution of electrode components. That is, the positively charged ferritin molecules form stable electrostatic interactions with the negatively charged GOx enzymes, forming a well-ordered and durable film. In addition, the ferritin shell protects the redox-active iron core from degradation, while its biocompatible and electroactive properties enhance electron transfer efficiency without compromising stability.

The need for long-term stability in BFC anodes cannot be overstated. Devices that rely on enzymatic reactions for energy conversion require not only high initial catalytic activity, but also sustained performance over time to be viable for continuous use. The stability results for the FGOx anodes suggest that cationized ferritin-based bioanodes can maintain high levels of enzymatic activity and electron transfer for extended periods, making them suitable for real-world BFC applications.

This invention demonstrates the successful fabrication of n-FGOx composite films through electrostatic spin coating-assisted LbL assembly. The LbL-assembled n-FGOx films show significant potential for bioelectronic applications, particularly as bioanodes in BFCs. The uniform integration of cationized ferritin and GOx was confirmed via detailed characterization using UV-vis spectroscopy, QCM, and cross-sectional FE-SEM. These techniques consistently revealed a homogeneous distribution, ensuring the structural integrity and uniformity of the composite films.

The precise control of the LbL assembly process was demonstrated by the linear increase in film thickness with the number of bilayers, reaching approximately 77 nm at 30 bilayers. This predictable growth allows the reproducible construction of multilayer films, which is crucial for practical applications. Electrochemical evaluations showed that electrodes with 30 bilayers exhibited optimal performance, primarily due to the role of cationized ferritin as an efficient redox mediator. The observed increase in current density with additional bilayers underscores that the enhanced redox activity of ferritin outweighs the slight increase in resistance due to the additional layers. Furthermore, the efficiency of cationized ferritin as a redox mediator was highlighted by its linear response to increasing glucose concentrations, confirming its applicability in biosensing technologies. The quasi-reversible and surface-controlled electron transfer processes at the anode, as evidenced by the linear relationship between the anodic peak current and scan rate, reinforce the effectiveness of ferritin in facilitating efficient electron transfer. Additionally, the multilayered anode structure demonstrated good stability, retaining 85% of its initial activity after 50 h of exposure to a glucose solution. This durability is critical for long-term use in real-world bioelectronic devices where sustained performance is essential.

In summary, this invention establishes the innovative use of cationized ferritin as a promising redox mediator for bioelectronic devices. The electrostatic interactions between cationized ferritin and enzymes enable the construction of robust multilayer films with enhanced electron transport properties. These findings provide a strong foundation for the development of efficient and stable bioanode structures, marking a significant advance in BFC technology and biosensor design. The exploitation of ferritin's unique redox properties represents a valuable advance in the quest for high-performance, durable bioelectronic systems.

The above-described description of the present invention is provided for illustrative purposes, and those skilled in the art to which the present invention pertains will understand that the present invention can be easily modified into other specific forms without changing the technical spirit or essential features of the present invention. Therefore, it should be understood that the examples described above are not limited but illustrative in all respects.

What is claimed is:

1. An electrode with improved electron transfer ability, comprising:
a support; and
a composite structure formed on the support and in which an enzyme layer assembly comprising cationized ferritin and an enzyme is repeated.

2. The electrode of claim 1, wherein the support is a support whose surface is functionalized with a carboxyl group.

3. The electrode of claim 2, wherein the support is a flat conductive support whose surface is functionalized with a carboxyl group.

4. The electrode of claim 1, wherein the cationized ferritin is ferritin functionalized with a cationic amine group.

5. The electrode of claim 1, wherein the enzyme is glucose oxidase.

6. The electrode of claim 1, wherein the support and the cationized ferritin, and the cationized ferritin and the enzyme are each bonded by electrostatic attraction.

7. The electrode of claim 1, wherein the enzyme layer assembly is repeated 5 times to 50 times and has a total thickness of 40 nm to 100 nm.

8. A method for manufacturing an electrode with improved electron transfer ability, the method comprising:
(a) preparing a support; and
(b) forming a composite structure in which an enzyme layer assembly comprising cationized ferritin and an enzyme is repeated on the support.

9. A bioelectrochemical device comprising the electrode according to claim 1.

10. The bioelectrochemical device of claim 9, wherein the bioelectrochemical device is a biofuel cell.

11. The bioelectrochemical device of claim 9, wherein the bioelectrochemical device is a biosensor.
